(19) United States
(12) Patent Application Publication
(10) Pub. No.: US 2008/0136591 A1
(43) Pub. Date: Jun. 12, 2008

(54) AUTOMATIC FUNCTIONALITY SWITCH FOR MOBILE DEVICES

(76) Inventor: Russell CALVARESE, Stony Brook, NY (US)

Correspondence Address: FAY KAPLUN & MARCIN, LLP, 150 BROADWAY, SUITE 702, NEW YORK, NY, 10038, US

(21) Appl. No.: 11/567,321

(22) Filed: Dec. 6, 2006

(51) Int. Cl. H04Q 5/22; G06K 7/10

(52) U.S. Cl. 340/10.1; 340/10.4; 235/462.01; 235/462.46

(57) ABSTRACT

A device having a first reader element acquiring data from an item using a first data acquisition method, a second reader element acquiring data from the item using a second data acquisition method, a user operated trigger generating a triggering signal for at least one of the first and second reader elements and an automatic context switch element initially activating the first reader element in response to the triggering signal, and switching the activation to the second reader element when the first reader element fails to acquire the data from the item.

### BACKGROUND

Supply chains for manufacturers, retailers and other businesses are very dependent on the ability to know at any time the location of supplies, products, goods etc. To accomplish this, various technologies have been developed to identify items being transported and record the item's location, status and other pertinent data. Bar codes, RFID tags and other means of identification and tracking are routinely placed on the items, and appropriate sensors are used to track them.

It may be useful to track items as they pass though known points of a transportation chain. For example, when items such as boxes are loaded or unloaded from a truck or other transport. This can be a very fast paced environment, where workers are busy moving items that may be heavy and bulky, and may not be in a position to manipulate multiple controls to operate the tracking devices.

### SUMMARY OF THE INVENTION

A device having a first reader element acquiring data from an item using a first data acquisition method, a second reader element acquiring data from the item using a second data acquisition method, a user operated trigger generating a triggering signal for at least one of the first and second reader elements and an automatic context switch element initially activating the first reader element in response to the triggering signal, and switching the activation to the second reader element when the first reader element fails to acquire the data from the item.

A method for receiving a triggering signal from a user actuated trigger, activating a first reader element utilizing a primary identification technology for acquiring data from an item in response to the triggering signal, determining whether the first reader element failed to acquire the data and, if the first reader element failed to acquire the data, activating a second reader element utilizing a secondary identification technology for acquiring the data from the item.

A device having a trigger element receiving user input to generate triggering signals, a first element providing a first functionality for the device, a second element providing a second functionality for the device and an automatic context switch activating the first element when receiving an initial triggering signal and activating the second element when the first element fails to provide the first functionality.

### BRIEF DESCRIPTION OF DRAWINGS

FIG. 1 is a diagram showing an embodiment of a tracking device with multiple functionalities according to the invention.

FIG. 2 is a flow chart showing exemplary steps for switching functionality in a tracking device according to the invention.

### DETAILED DESCRIPTION

The present invention may be further understood with reference to the following description and to the appended drawings, wherein like elements are referred to with the same reference numerals. The exemplary embodiments of the present invention relate to a mechanism for automatically switching between functionalities of a mobile device. More specifically, the invention relates to switching between a first tracking (or input) mode to another tracking (or input) mode when the first mode fails. Those skilled in the art will understand that the exemplary embodiments of the present invention are described with reference to tracking items using RFID, bar codes or other identification technologies. However, the present invention is not limited to tracking technologies, but may be used for any functionalities where the device is initially triggered to start or initiate a first functionality, and after a failure of the first functionality, a second functionality is selected. Thus, the use of a tracking functionality using different types of readers is only exemplary.

Inventory control and other processes are based on being able to track the location and status of various items within a supply or production chain. For example, a retailer may want to know what items are located in a certain store at a given time. A manufacturer may want to know what raw materials arrive at a plant, and what products are shipping. In these and many other situations it is necessary to identify the items of interest and track their location and status.

Various technologies are available for identification and tracking. For example, bar codes may be affixed on the items and may be read by a laser or image scanner. More recently, radio frequency identification (RFID) tags have been embedded in items so that an RFID reader may be used to track the items. The item's identity as well as other pertinent data may be encoded in the RFID tag, which either broadcasts a low power transmission containing the data (active RFID tag) or transmits the data via backscatter when interrogated by the RFID reader (passive RFID tag). Other technologies may also be used to identify and track items, such as optical readers, manual input devices, etc.

One may be interested in tracking items such as every box that is loaded or unloaded from a truck, pallet, railroad car or other transport. Workers moving the items may be tasked to operate a scanner or a reader to track the items while moving the items. This may be difficult if the items are heavy or bulky, or if the working environment makes it difficult to handle the scanning equipment. Typically the worker has to stop moving boxes then pick up the scanner and trigger its read function. These tasks use up additional time, reducing efficiency of the loading/unloading task.

An additional difficulty is encountered when multiple technologies are used to track the items. For example, some of the items may be fitted with RFID tags, other items with optical bar codes, and yet others with codes that are read by different technologies. The devices used to track those items are typically designed to use only one technology, or at best require activation of the secondary tracking technology by the user when necessary.

According to the exemplary embodiments of the present invention, embodiments of a tracking device are provided that incorporate multiple tracking technologies. In addition, the exemplary embodiments provide for automatic switching of the tracking device between a primary tracking function to one or more secondary tracking functions. Automatically switching between multiple functionalities is advantageous for several reasons. The user does not have to manipulate controls of the scanning device to switch functionality, leaving his hands free to continue moving the items. There is no need for the worker to pause to select the correct tracking technology to be used, since this is done automatically by the exemplary tracking device.

According to the exemplary embodiments, the worker may continue to perform their assigned task without taking a separate action to interact with the device to have the device switch functionalities. This may save time for the worker because they can focus their attention on the primary task (e.g., loading boxes) without having to interact with the device to switch to the needed functionality. In fact, the worker may not even need to know what the functionality to which the device is switching. The exemplary embodiments of the present invention allow the worker to merely continue with their assigned task while the device is switched to the needed functionality.

In addition, the exemplary embodiments allow for a simplified design for the tracking device since there is no need to provide an additional trigger function or means to select a different functionality using some input function provided by the system. This is especially important in miniaturized devices, where there is little room for additional controls, and providing a second trigger function may pose mechanical or electrical design challenges.

RFID tags provide for very fast identification of the tracked items, such as boxes that are loaded and unloaded from transports. However, not all tracked items have RFID tags, since they represent a fairly new technology. Many tracked items employ bar codes read by a laser scanner or by an optical scanner, and yet other tracked items use identification numbers that are read by the user and entered in an input element of the tracking device. RFID tags may also be damaged or become non-readable for various reasons, requiring the user to switch to a secondary method of identification.

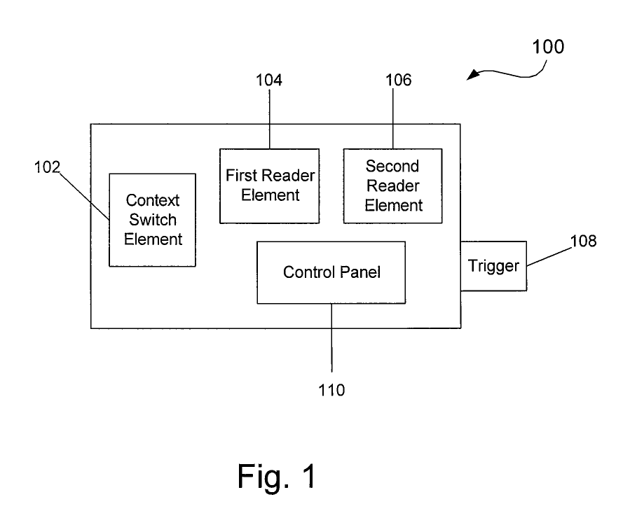

FIG. 1 shows a block diagram of an exemplary embodiment of a tracking device 100 with automatic functionality context switch. The exemplary tracking device 100 may be a wearable device, e.g., where the device or a portion of the device is secured to the user's body such as a finger, hand or arm. However, those skilled in the art will understand that the present invention may be applicable to any mobile device having a triggering function, whether the device is wearable or not.

The device 100 is provided with a first reader element 104 using a primary identification technology, for example a reader for RFID tags. A second reader element 106 using a secondary identification technology is provided. For example, the second reader element 106 may comprise a laser barcode scanner or an optical code reader. A control panel 110 may be included in the exemplary tracking device 100. The control panel 110 may comprise input elements such as a keypad, soft keys, touch screen or other means to enter data in the device. A display and user notification function may also be included in the control panel 110.

The exemplary tracking device 100 comprises a trigger 108 which the operator uses to initiate a data read attempt by the tracking device 100. Those skilled in the art will understand that the trigger 108 may be any type of triggering mechanism (e.g., mechanical, electrical, acoustical, optical, etc.) and may be a separate component or part of another component (e.g., the trigger 108 may be a button or key on the control panel 110). In the initial configuration of the device 100, the trigger 108 initiates the data read attempt using the first (or primary) reader element 104. The device 100 also includes an automatic context switch element 102 that is used to switch between the primary (first reader element 104) and the secondary (second reader element 106) identification technologies used by the device 100.

The context switch element 102 may be implemented as hardware, software or a combination thereof. For example, the context switch element 102 may be implemented as software that is executed by a processor. The instructions executed by the processor may include the receipt of a triggering signal from the trigger 108 which generates a command to initiate the first reader element 104. The instructions may also initiate a timer to determine if the first reader element 104 has collected data within a predetermined time period. When the time period has elapsed, the instructions may generate a signal to deactivate the first reader element 104 and another signal to activate the second reader element 106 if the first reader element 104 has not collected the tracking information. Additional scenarios for activating the second reader element 106 will be described in greater detail below. Those skilled in the art will understand that the above instructions that are described as being executed by a processor may also be implemented in hardware components such as timer circuits and control circuits.

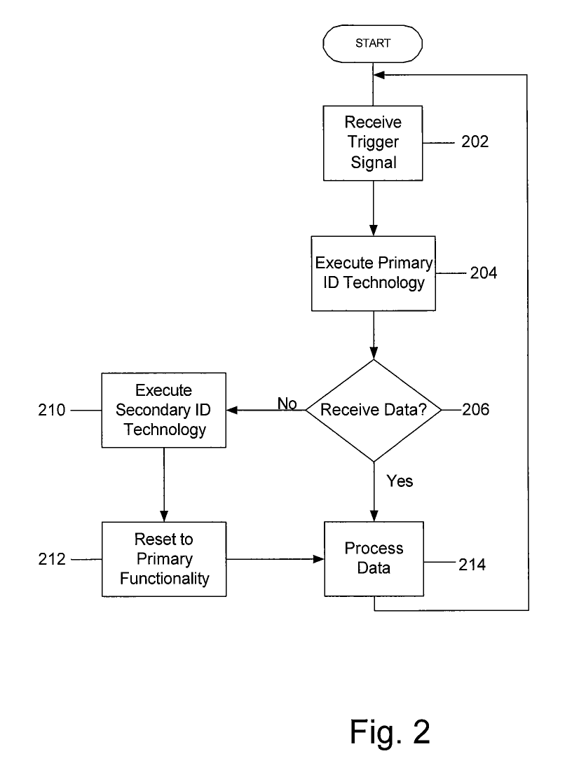

FIG. 2 shows a flow chart of an exemplary process taking place during the automatic context switching. The process of FIG. 2 will be described with reference to the device 100 of FIG. 1. In step 202, the automatic context switch 102 receives a trigger signal from the trigger 108 which may be generated, for example, when the user presses the trigger 108. Upon receipt of the trigger signal, either the automatic context switch 102 (or some other component) initiates the primary identification technology in step 204. In this example, the first reader element 104 may be an RFID reader that transmits an RFID interrogation to attempt to collect data from RFID tags on the item. In the above example, it is not necessary that the automatic context switch element 102 generate the activation signal, i.e., the purpose of the automatic context switch element is to determine which identification technology be initiated, not that the automatic context switch element 102 necessarily generates the initiation signal.

In step 206, the automatic context switch element determines whether the primary identification technology was successful in receiving a reply from the RFID tag. If an appropriate reply from the RFID tag is received, the process continues to step 214 where the identification data is processed. For example, additional information may be added, and the data may be stored, sent to a remote site or otherwise manipulated as needed.

When the primary identification technology is not successful, the functionality of the tracking device 100 is changed, and the automatic context switch element 102 (or other component) activates the secondary identification technology in step 210. The execution of step 210 may be based on a predetermined time period. For example, if data is not received within 2 seconds of initiating the primary identification technology, the secondary identification technology is initiated. In the exemplary embodiments, the second reader element 106 may be a laser barcode reader, an optical reader or by some other identification device. In other embodiments, the secondary identification technology may include enabling a data input device so that the user may enter desired data manually.

The process may reset to the primary identification functionality in step 212. For example, this may occur after a predetermined period of time, or after a read attempt using the secondary technology is initiated. The data received from the secondary functionality, if any, may be processed as described above in step 214. The process may then continue as long as the device is active to monitor for additional trigger signals.

Those skilled in the art will understand that the context switching between functionalities of the tracking device according to the invention may take place more than once. For example, if the secondary identification technology fails, the unit may switch to a third identification technology. Those skilled in the art will also understand that the present invention is not limited to the tracking and identification technologies listed above, but instead may be used with other functionalities of a mobile device.

The following scenarios describe more fully the operation of exemplary embodiments of the present invention. In one example, when the primary read attempt times out, the trigger 108 function automatically changes to activate the secondary read function when the user presses the trigger 108 again, generating a second triggering signal which initiates the second data read attempt. After one read attempt using the second reader element 106, the trigger 108 reverts to activating the first reader element 104, and the device 100 is ready to identify the next item.

In another example, after failure of the primary reader element 104 to obtain identification data, a data read attempt using the second reader element is initiated, without the need to press the trigger 108 again. For example, the laser barcode reader is automatically activated after a failed RFID read attempt, following reception of a single triggering signal by the automatic context switch element 102.

A different exemplary scenario involves automatically configuring the tracking device 100 to accept an identification input from the user, after failure of the data read attempt by the first reader element 104. A display and a user input functionality may be activated on the control panel 110, and some audible or visual user feedback may be provided to prompt a numeric input from the user. After the user input is completed, or after some preset time interval, the device 100 automatically switches the context back to the primary identification mode so that the unit is ready to track the next item.

As can be seen from the above scenarios, the exemplary embodiments of the present invention allow the worker to continue with their assigned task without additional interaction with the device in order to switch functionalities. The worker may continue with the assigned task and save both the time and effort associated with interacting with the device to switch functionalities and then refocusing on the primary task.

The present invention has been described with reference to specific exemplary embodiments. Those skilled in the art will understand that changes may be made in details, particularly in matters of shape, size, material and arrangement of parts. Accordingly, various modifications and changes may be made to the embodiments. The specifications and drawings are, therefore, to be regarded in an illustrative rather than a restrictive sense.

What is claimed is:

1. A device, comprising:
a first reader element acquiring data from an item using a first data acquisition method;
a second reader element acquiring data from the item using a second data acquisition method;
a user operated trigger generating a triggering signal for at least one of the first and second reader elements; and
an automatic context switch element initially activating the first reader element in response to the triggering signal, and switching the activation to the second reader element when the first reader element fails to acquire the data from the item.

2. The device according to claim 1, wherein the first reader element comprises an RFID reader.

3. The device according to claim 1, wherein the second reader element comprises at least one of a barcode laser scanner, an optical code reader and a user input device.

4. The device according to claim 1, wherein the automatic context switch element includes a processor for receiving the triggering signals and for selectively activating the first and second reader elements.

5. The identification device according to claim 1, wherein the automatic context switch element switches the activation after a data read attempt time out of the first reader element following the triggering signal.

6. The identification device according to claim 1, wherein the automatic context switch element switches assignment of the trigger from activation of the first reader element to activation of the second reader element after failure to acquire the data.

7. The identification device according to claim 1, wherein the automatic context switch returns the activation to the first reader element after activation of the second reader element.

8. A method, comprising:
receiving a triggering signal from a user actuated trigger;
activating a first reader element utilizing a primary identification technology for acquiring data from an item in response to the triggering signal;
determining whether the first reader element failed to acquire the data; and
if the first reader element failed to acquire the data, activating a second reader element utilizing a secondary identification technology for acquiring the data from the item.

9. The method according to claim 8, further comprising:
reactivating the first reader element after acquiring the data with the second reader element.

10. The method according to claim 8, wherein the activating the second reader element includes receiving a second trigger signal from the user actuated trigger.

11. The method according to claim 8, wherein the first reader element is an RFID reader that queries an RFID tag of the item as the primary identification technology.

12. The method according to claim 8, wherein the second reader element is one of a laser barcode scanner and an optical code scanner as the secondary identification technology.

13. The method according to claim 8, wherein the second reader element is a user input device that receives user input as the secondary identification technology.

14. The method according to claim 8, further comprising activating the second reader element after a read attempt timeout of the first reader element.

15. A device, comprising:
a trigger element receiving user input to generate triggering signals;
a first element providing a first functionality for the device;
a second element providing a second functionality for the device; and
an automatic context switch activating the first element when receiving an initial triggering signal and activating the second element when the first element fails to provide the first functionality.

16. The device according to claim 15, wherein the automatic context switch activates the second element upon receipt of a further triggering signal.

17. The device according to claim 15, wherein the automatic context switch activates the second element after a predetermined time period from receipt of the initial triggering signal.

18. The device according to claim 15, wherein the automatic context switch, after activating the second element, is reconfigured to activate the first element upon receipt of a subsequent triggering signal.

19. The device according to claim 15, wherein the first and second functionalities are related to item tracking.

20. A device, comprising:
a first reading means for acquiring data from an item using a first data acquisition method;
a second reading means for acquiring data from the item using a second data acquisition method;
a triggering means for generating a triggering signal for at least one of the first and second reading means; and
a switching means for activating the first reading means in response to the triggering signal, and switching the activation to the second reading means when the first reading means fails to acquire the data from the item.
